(19) United States
(12) Patent Application Publication
(10) Pub. No.: US 2006/0210735 A1
(43) Pub. Date: Sep. 21, 2006

(54) Process and mould for producing a longitudinal member combining plastic and metal

(75) Inventors: Roberta Colombo, Bollate (IT); Alberto Bruschi, Arese (IT); Elena Bruschi, Arese (IT); Barbara Bruschi, Arese (IT)

Correspondence Address: BROWDY AND NEIMARK, P.L.L.C.;624 NINTH STREET, NW, SUITE 300, WASHINGTON, DC, 20001-5303, US

(73) Assignee: Mold & Moulds Inc., East Brunswick, NJ (US)

(21) Appl. No.: 11/083,093

(22) Filed: Mar. 18, 2005

(51) Int. Cl. B31B 45/00

(52) U.S. Cl. 428/34.1; 264/259; 425/129.1

(57) ABSTRACT

The process consists in inserting into a mould (1) a metal insert (4) having ends (4a) spaced from each other, in injecting plastic material in a fluid state into the mould (1) to form a shaped body (7) incorporating the metal insert (4), and in providing at the ends (4a) modified areas (9) without plastic material, to permit shrinkage of the shaped body (7) being formed without generating combined bending and compressive stress on the metal insert (4). The mould comprises a moulding cavity (3) designed to house a metal insert (4) having ends (4a) spaced from each other, devices (5) for injecting plastic material into the moulding cavity (3) to produce a shaped body (7) incorporating the metal insert (4), and operating devices (8) designed to define at the ends (4a) of the metal insert (4) modified areas (9) without plastic material.

### FIELD OF THE INVENTION

The invention relates to a process and a mould for producing a longitudinal member or beam combining plastic and metal.

In particular the invention concerns the production of a longitudinal member or beam longer than half a metre, for example two or more metres, permanently combining moulded plastic and at least one metal element such as a bar, or a lamina or a tubular element of length similar to that of the longitudinal member.

### DESCRIPTION OF THE PRIOR ART

As known, one of the most important phenomena to be taken into consideration in moulding of plastic is the phenomenon of shrinkage which occurs in the moulds: when the plastic cools and solidifies, it tends to contract with respect to the walls of the mould.

The extent of the shrinkage can vary—according to the plastic used and the moulding techniques—substantially between approximately one and two percent of the initial dimensional values, in the mould.

This means that in the case of production of a plastic longitudinal member or beam approximately two metres long, for example to form a doorpost or a bed slat or a ceiling beam or a bar for furnishing elements, or a support for structures of various types, the shrinkage is very manifest as it can be between two and four centimetres.

Said phenomenon of shrinkage, in addition to constituting a problem in set-up of the moulds and moulding techniques, has the serious drawback of preventing the production of elongated composite elements, originally and permanently combining metal and moulded plastic.

In fact, if a metal element such as a bar, or a lamina or a tubular element of length similar to that of the mould is inserted in the mould to reinforce a plastic longitudinal member or beam or to form on the same a partly metallic surface, said shrinkage of the plastic determines, once the same has cooled, evident negative phenomena.

In fact the metal element is not subject to the phenomenon of shrinkage and therefore maintains its initial dimensions, while the plastic contracts its initial dimensions.

Thus, if the moulding cavity and the metal element have the same maximum dimensions, after moulding an unacceptable protrusion of the metal element occurs with respect to the plastic. For example, in said case of a longitudinal member of approximately two metres, the metal element will protrude by one or two centimetres from each end of the longitudinal member.

Cutting and adjustment operations must then be performed to obtain the required product.

If on the other hand a remedy to this situation is sought by inserting in the moulds metal bars or laminas of dimensions smaller than those of the mould and substantially already corresponding to the predicted dimensions of the plastic after shrinkage, it is likely that the metal element will bend.

In fact although initially the plastic covers and engages the ends of the metal elements, the same are necessarily dragged back by the plastic as it contracts, consequently bending the metal elements.

The force exerted by the plastic during contraction is in fact very high and substantially cannot be countered.

This results in longitudinal members that are not perfectly straight or with defects and warping due to flexion of the metal elements inserted.

In practice metal elements can be inserted without any problems in a mould for plastic only when they are not particularly long and therefore the phenomenon of shrinkage of the plastic has limited or negligible negative consequences on them. This is an important limitation as it prevents the formation of beam or longitudinal member elements that could combine the duration, lightness and absence of corrosion of the plastic with the resistance to stress of the metal bars.

Neither it is possible to produce longitudinal members or similar that are already at moulding level coated at least partly and permanently by metal laminas able to strengthen and improve the appearance of said longitudinal members, and which furthermore permit the typical joints for screw connection or welding with other elements.

Vice versa it is not possible to form longitudinal members of various shapes with a metal core and plastic coating, which gives them a stable colour and surface characteristics chosen as required.

The cost of these composite longitudinal members, if it were possible to produce them, would be limited due to the inexpensiveness of the metal that could be used: it would cost less than the high quality plastic necessary to achieve, with said plastic alone, adequate functional characteristics and resistance.

The metal elements completely embedded in the plastic could be unrefined and also the plastic used, which would not be subject to particular requirements as regards resistance, could be of the inexpensive type.

### SUMMARY OF THE INVENTION

In this situation the aim of the invention is to conceive a process and a mould for producing a longitudinal member or beam combining plastic and metal, able to remedy the above-mentioned drawbacks.

A further important aim of the invention is to conceive a process and a mould that permit the production, directly at moulding level, of a satisfactory and well-finished large-size longitudinal member with the inclusion of metal inserts or elements of dimensions similar to those of the mould.

The aims specified are achieved by a process for the production of a longitudinal member combining plastic and metal, consisting: in placing in a mould at least one metal insert having ends spaced from each other; in injecting into said mould plastic in a fluid state to form a plastic shaped body at least partially incorporating said metal insert; and in providing at least one of said ends of said metal insert at least one modified area without plastic, to permit shrinkage of said shaped body being formed without generating combined bending and compressive stress on said metal insert.

The mould to produce a longitudinal member combining plastic and metal comprises: at least one moulding cavity designed to house at least one metal insert having ends spaced from each other; devices for injection of plastic in a fluid state in said moulding cavity, to produce a shaped plastic body at least partially incorporating said metal insert; and operating devices designed to define, at least one of said ends of said metal insert, at least one modified area without plastic.

### BRIEF DESCRIPTION OF THE DRAWINGS

Preferred embodiments of the invention are now described, as non-limiting examples, illustrated in the attached drawings in which:

FIG. 1 shows a mould in the closed position, consisting of two mould halves;

FIG. 2 illustrates a mould half of the preceding figure, in an isolated position;

FIG. 3 highlights a median section of the mould of FIG. 1;

FIG. 4a indicates only schematically the mould of the preceding figures and an initial moulding phase;

FIG. 4b indicates a moulding phase subsequent to that of FIG. 4a;

FIG. 5 shows a longitudinal member produced with the mould and the moulding process of the preceding figures;

FIG. 6a shows schematically and partially a further embodiment of the mould and an initial moulding phase;

FIG. 6b is similar to FIG. 6a and highlights a moulding phase subsequent to the one of FIG. 6a;

FIG. 7 shows a portion of a longitudinal member produced with the mould and the moulding process highlighted in FIGS. 6a and 6b;

FIG. 8 schematises a portion of a further embodiment of the mould and an initial moulding phase;

FIG. 9 schematises a portion of the longitudinal member produced with the mould and process of FIG. 8;

FIG. 10 illustrates schematically a portion of a further embodiment of the mould and an initial moulding phase; and

FIG. 11 illustrates a portion of the longitudinal member produced with the mould and the moulding process shown in FIG. 10.

### DESCRIPTION OF THE PREFERRED EMBODIMENTS

In the drawings, the moulding process is illustrated in particular in FIGS. 4a, 4b, 6a, 6b, 8, 10, which also schematically show the mould used. The first figures from 1 to 3 show the mould in detail, while in FIGS. 5, 7, 9, 11 the longitudinal member or beam obtained is shown.

The mould is indicated overall by number 1.

It comprises two half moulds 2 moving with respect to each other in a relative sense and defining at least one moulding cavity or seat 3.

The moulding cavity 3 is designed to house and position at least one metal element or metal insert 4 defined for example by a bar with longitudinal dimensions similar to but shorter than the maximum dimensions of the moulding cavity 3. In particular, in the metal insert 4, spaced or terminal ends 4a can be distinguished defining a main direction of development 4b of the insert.

In a per se known manner the mould 1 is provided with devices for injection 5 of a plastic material in a fluid state and extraction 6 of the finished product, consisting in a longitudinal member or beam or similar product of large dimensions, indicated overall by 10 and combining at the origin and in a fixed manner metal and plastic. The injection devices can be of any type: of the type for so-called normal pressure moulding or for gas, water-assisted, bicomponent moulding etc. The mould highlighted in FIG. 3 is designed for so-called gas moulding.

In any case a shaped body 7 in plastic material is formed in the moulding cavity 3, combined with the metal insert 4. The metal insert 4 can be totally embedded in the shaped body 7 or partially exposed.

For example, it is partially exposed when it is a lamina that forms a metal edge of a longitudinal member 10 for a window jamb or door post or patio door post. Even when the metal insert 4 is exposed, at least one portion of the same is enveloped by the shaped body 7 and preferably both ends 4a are inside the shaped body 7 made of plastic material.

The distance between the ends 4a can be of any length, but preferably will be similar to and shorter than the maximum length of the shaped body 7, parallel to the main direction of development 4b, and between half a metre and two or more metres, for example.

The metal material used for the insert 4 can be any metal, but stainless steel is preferable if there are exposed sections. Analogously the plastic material of the shaped body 7 can be any plastic, although polypropylene is particularly suitable for forming a shaped body 7 of large dimensions and with good functional characteristics.

The mould 1 is provided with operating devices 8 designed to define at least one modified or protected or free area 9, without plastic material, to permit shrinkage of said plastic material without combined bending and compressive stress on the metal insert 4, i.e. without stress applied on the ends of the metal insert and directed substantially axially to the same, or parallel to its main direction of development 4b.

Two modified areas 9 are preferably provided obtained at both spaced ends 4a of the metal insert 4.

In particular the modified areas 9 are provided in a position immediately consecutive to the ends 4a, parallel to the main direction of development 4b of the metal insert 4.

One single modified area 9 is provided at one single end 4a when the shrinkage of the plastic material is relatively limited and when only one of the two ends 4a is incorporated in the plastic material and the other is exposed.

Each modified area 9 is set up before the plastic material is placed in the mould 1, or when the plastic material is still in a substantially fluid state and has not yet undergone substantial shrinkage.

The operating devices 8 can be structured in various ways.

In the version shown in FIGS. 1, 2, 4a, 4b, 6a, 6b the operating devices 8 comprise an actuator mechanism 8a and a punch 8b controlled by the actuator mechanism 8a.

The latter consists of a pneumatic-hydraulic cylinder or a linear electric actuator, engaged in the mould 1 outside the moulding cavity 3.

The punch 8b can be inserted into and removed from the moulding cavity 3 via a respective passage in the mould 1, positioning itself immediately adjacent to one end 4a of the metal insert 4. Its presence defines a modified area 9 consisting of a cavity 9a in the fluid plastic material.

In FIGS. 1, 2, 4a, 4b the punch 8b is a shaped rod running crosswise to the main direction of development 4b, while in FIGS. 6a, 6b the punch 8b is a shaped rod substantially aligned with the main direction of development 4b.

Furthermore, in the technical solution shown in FIGS. 6a, 6b, the punch 8b is the support of the metal insert 4.

This embodiment is useful when the mould 1 is not already provided with appropriate elements or shapes for supporting the metal insert 4.

The punch 8b is extracted before substantial shrinkage and hardening of the plastic material, to prevent said punch being blocked by the shrinkage.

To make it possible for the punch 8b to be extracted as late as possible, i.e. only when the plastic material has reached a degree of hardness such as to conserve the cavities 9a and if necessary also such as to sustain the metal insert, the punch 8b is shaped so that it does not have any points where the plastic material can catch.

For example the punch 8b can be cylindrical or preferably truncated cone-shaped, tapering towards the metal insert 4.

Furthermore the surface of the punch is smooth and protected by a lubricating fluid designed to assist the smooth flow of the plastic material.

Heating of the punch beforehand, for example to fifty degrees centigrade, also helps it to run smoothly through the plastic material.

The operating devices 8 can also be made of at least one spacer body 9b totally embedded in the shaped body 7 and designed to deform or shatter due to interference with the metal insert 4 during shrinkage of the plastic material.

Two spacer bodies 9b are preferably provided, one for each end 4a of the metal insert 4. Furthermore the spacer bodies 9b can be directly engaged or supported by the ends 4a.

The engagement can be of the mechanical type, for example by slotting or screwing or gluing.

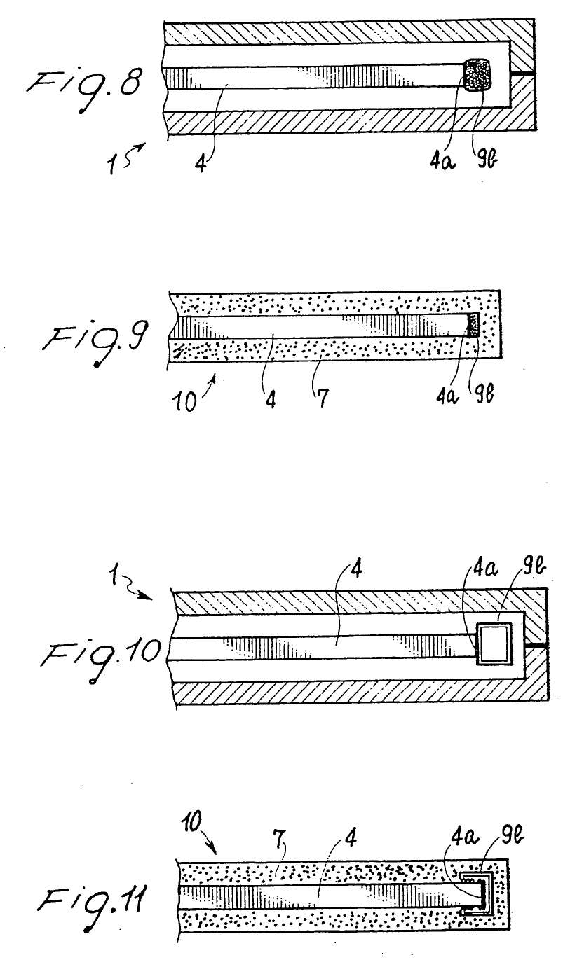

The spacer bodies 9b can be structured in various ways: as a guide, they can be blocks of elastically deformable material, for example hard rubber or elastoplastic material, as illustrated schematically in FIGS. 8, 9 or collapsible or shatterable hollow casings, for example shells or box-like elements, with thin walls, in the order of one millimetre, as illustrated in FIGS. 10, 11.

In any case the spacer bodies 9b will have sufficient resistance to withstand the pressure of the fluid plastic material, when the same is injected into the moulds, but not sufficient to counter the pressures formed between the spacer bodies and the metal insert, when the spacer bodies are dragged by the shrinkage movement of the plastic material as the same hardens. In this regard it should be noted that the pressure of the fluid plastic material in the moulds at the time of injection varies according to the moulding techniques between approximately one hundred and five hundred kilograms per square centimetre, while the pressure created between the metal insert and the spacer bodies, due to dragging of the latter by shrinkage of the plastic material, is greater than one ton per square centimetre.

The materials and structures of the spacer bodies 9b can therefore be chosen solely according to resistance to the injection pressure: in any case the same are crushed or shattered or collapse when they are dragged counter to the metal inserts 4.

The process for producing a longitudinal member or similar 10 combining plastic and metal is as follows.

At least one metal insert 4 having widely spaced ends 4a and defining a main direction of development 4b is placed in a mould 1; a shaped plastic body 7 is formed in the mould 1 by injection of fluid plastic material, in a per se known manner.

At least one modified area 9 not engaged by the plastic material is then obtained in the shaped body 7, at at least one of the ends 4a, prior to shrinkage of said plastic material.

Preferably two modified areas 9 are provided aligned in the main direction of development 4b and positioned consecutively at the ends 4a.

The free areas 9, without plastic material, eliminate the combined bending and compressive stress on the metal insert 4, i.e. the force applied to the ends 4a of the metal insert 4 and directed axially to the same or in any case parallel to its main direction of development 4b.

In an embodiment of the process, each modified area 9 is provided by obtaining in the plastic shaped body 7 at least one cavity 9a designed to house one end 4a of the metal insert 4.

Each cavity 9a is obtained preferably by insertion and removal of at least one punch 8b in the shaped body 7.

Preferably the punch 8b is inserted before introduction of the plastic material and is removed immediately after partial hardening of said plastic, while the phenomenon of shrinkage is still very slight.

When the mould 1 is not already provided with appropriate supporting elements, the punch 8b can be used also to support the ends 4a of the metal insert 4. In this case the punches are parallel to the main direction of development 4b and, if truncated cone-shaped and/or heated and/or lubricated superficially, can be extracted when the plastic material is hard enough to sustain the metal insert. In a further embodiment of the process each modified area 9 is obtained by embedding in the shaped body 7 at least one spacer body 9b, designed to withstand the pressure of the plastic material at the time of injection of the same, but deformable or shatterable by interference with the metal insert 4 in the presence of drag due to shrinkage of the plastic material.

Each spacer body 9b can be directly engaged at one end 4a of the metal insert, by slotting or gluing or screwing.

The longitudinal member 10, obtained by means of the mould and process described above, is distinguished by various characteristics.

It is an element which can be large, for example two or more metres long, combining at the origin and in a permanent manner plastic (defining the shaped body 7) and metal (defining the metal insert 4). It can form beams, struts, supports, cross members, furnishing components and elements, components for hulls and vessels or structural elements for building. It can also advantageously simulate the functions and uses of wooden planks and sleepers, metal elements in constructions and fencing, always combining the duration, lightness and insensitivity to local or environmental or atmospheric corrosive agents typical of plastic with the resistance and rigidity of metal.

The plastic can give the longitudinal members a variety of colours and surface characteristics, while the metal inserts also permit the usual simple mechanical type joints such as welding and screw connections.

The metal insert 4 can be only partially incorporated by the shaped body, for example it can emerge to provide a partial covering of the shaped body 7 which can be used for connections with other elements or to protect points subject to high surface stress.

If the metal insert 4 emerges from the shaped body 7, it is preferably made of a high quality metal such as stainless steel or aluminium or other, while if it is completely internal it can be made of inexpensive metal and also embedded rough, without surface finish.

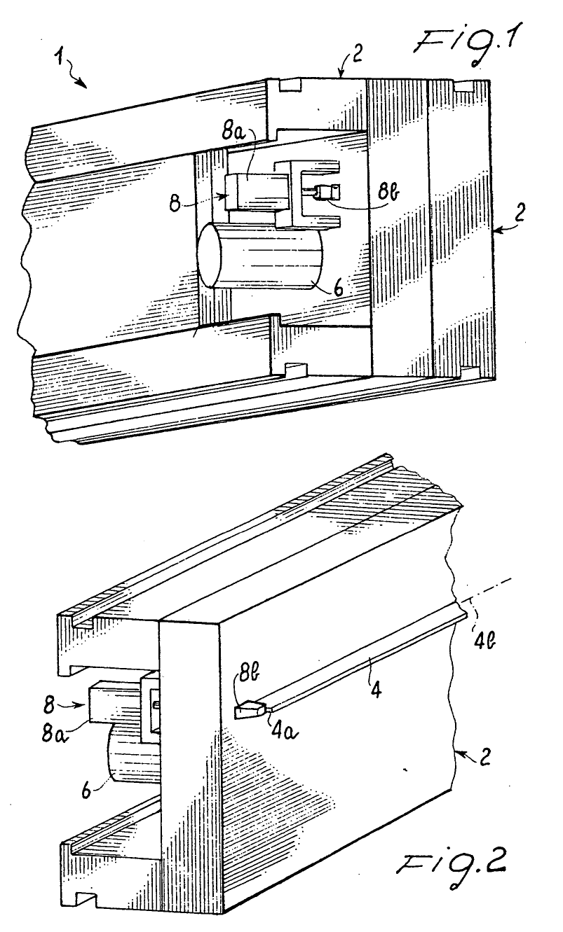

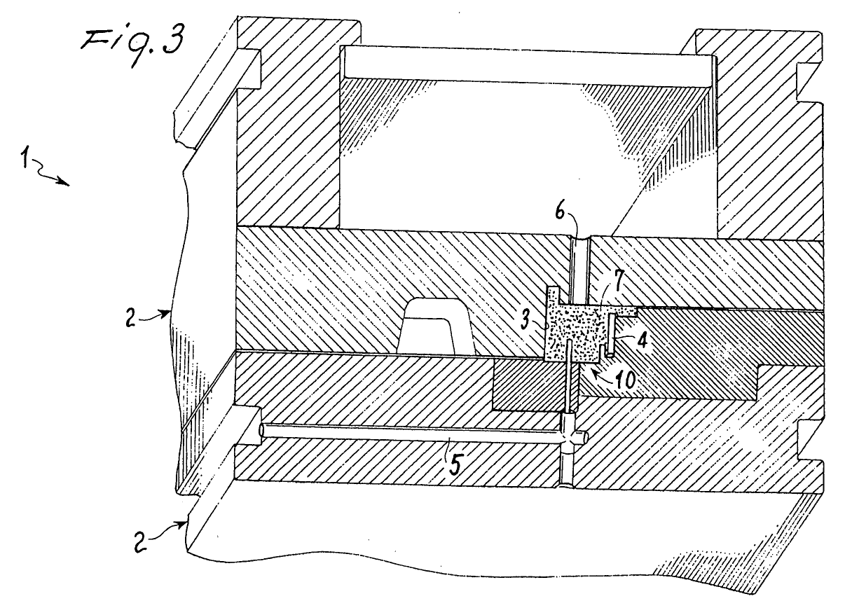

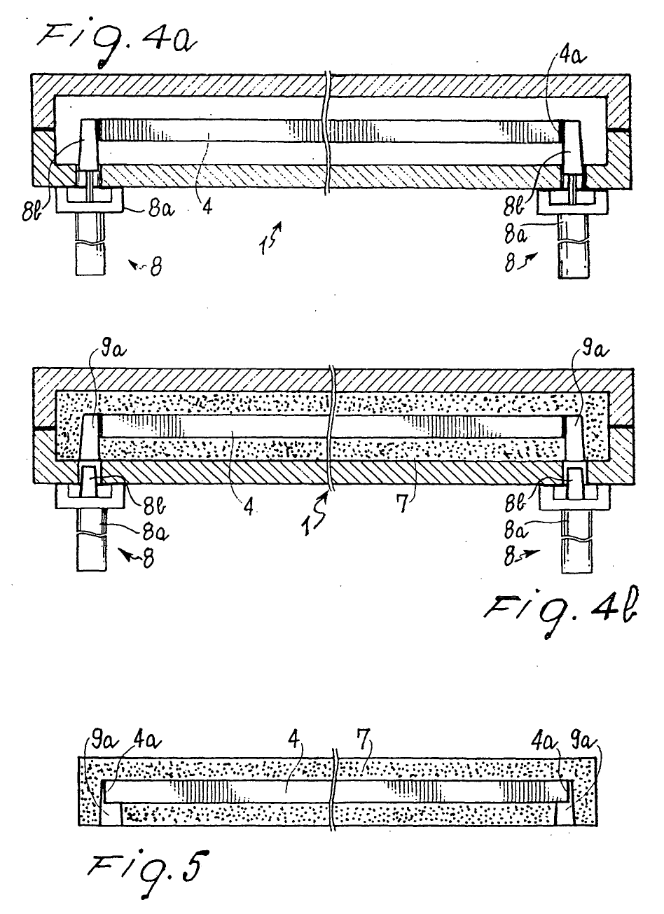

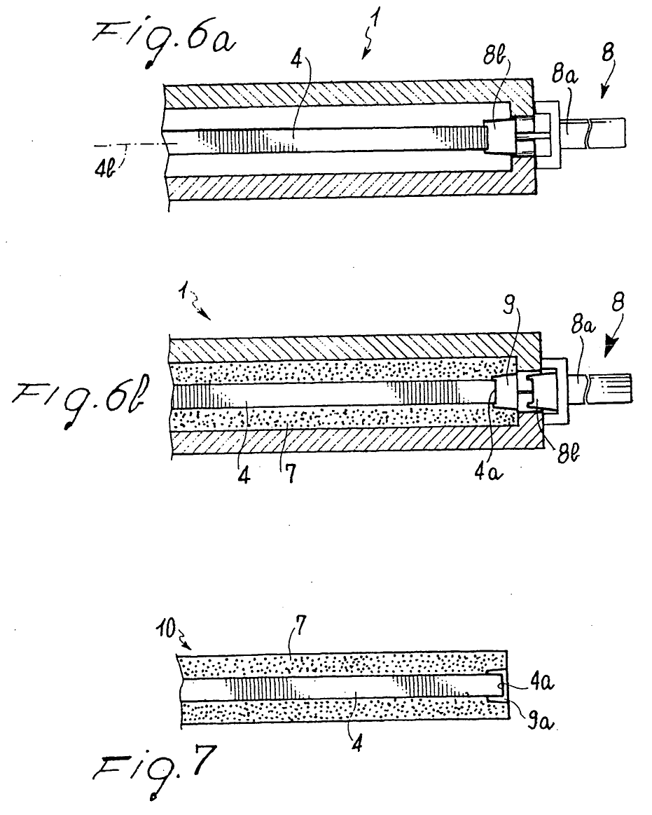

A characteristic of the longitudinal member 10 is that of presenting at least one modified area 9 at at least one of the ends 4a of the metal insert. This modified area 9 is for example a cavity 9a obtained in the shaped body 7 and the cavity 9a is open on at least one side of said shaped body. It can pass right through when it is obtained crosswise to the main direction of development 4b of the metal insert. In the longitudinal member 10—finished—the cavities 9a are at least partially crossed by the metal insert 4, as can be seen in FIGS. 5 and 7.

In fact the phenomenon of shrinkage of the plastic material moves these cavities nearer together along the main direction of development 4b, so that they surround the ends 4a of the metal insert.

As can be seen also from FIG. 7, if the cavities 9 are obtained coaxially with the metal insert 4, the longitudinal member 10, once completed, can present an insert 4 which develops throughout the length of the longitudinal member itself.

The cavities 9a of the longitudinal member 10 already finished can if necessary be closed by plugging elements, for example made of plastic, if necessary inserted while hot.

The free areas 9 can also be completely internal to the shaped body 7 when they are provided by spacer bodies 9b initially positioned at the ends 4a.

The invention offers important advantages.

It finally solves the problem of the substantial incompatibility between moulded plastic and metal inserts embedded in it for the production of large longitudinal members or similar, reinforced internally substantially throughout their length. Due to the provision of said free areas 9, the plastic material can shrink considerably without causing either undesired protrusion of the metal inserts or compression of the same such as to determine flexion, deformation and defects.

The combined bending and compressive stress on the ends of the metal inserts is in fact eliminated, i.e. the compression on the ends of the inserts, which is what causes the deformations. In fact, as already said, as the plastic material shrinks it exerts pressures that can exceed one ton per square centimetre.

It is therefore also possible to combine long relatively thin metal laminas with the plastic material in the moulds to determine a perfectly smooth metal face of the longitudinal members produced.

The items that can be produced in this way have exceptional properties of duration and resistance, limited costs and also the possibility of traditional mechanical use with other items. They can also be adapted to very varied aesthetic requirements, for example colouring or surface characteristics, using per se known techniques for the moulding of plastic.

1. Process for producing a longitudinal member combining plastic and metal, consisting:
in inserting in a mould at least one metal insert having ends spaced from each other;
in injecting into said mould plastic material in a fluid state to form a shaped plastic body at least partially incorporating said metal insert;
and in providing at least one of said ends of said metal insert at least one modified area without plastic material, to permit shrinkage of said shaped body being formed without generating combined bending and compressive stress on said metal insert.

2. Process as claimed in claim 1, in which said metal insert has a main direction of development and in which said at least one modified area is obtained consecutively to said metal insert, parallel to said main direction of development.

3. Process as claimed in claim 1, in which said metal insert presents a main direction of development and in which in said shaped body two said modified areas are obtained positioned consecutively at said two ends, parallel to said main direction of development.

4. Process as claimed in claim 1, in which said at least one modified area is produced by obtaining at least one cavity in said plastic material.

5. Process as claimed in claim 4, in which said at least one cavity is produced by providing at least one punch in said mould and by removal of said at least one punch during partial hardening of said plastic material.

6. Process as claimed in claim 5, in which said metal insert is supported in said mould by said at least one punch.

7. Process as claimed in claim 1, in which said at least one modified area is produced by providing in said mould at least one spacer body which deforms or shatters due to interference with said metal insert during shrinkage of said plastic material.

8. Process as claimed in claim 7, in which said at least one spacer body is provided directly engaged in said metal insert.

9. Mould for producing a longitudinal member combining plastic and metal, comprising:
at least one moulding cavity designed to house at least one metal insert having ends spaced from each other;
devices for injection of plastic material in a fluid state into said moulding cavity, to produce a shaped plastic body at least partially incorporating said metal insert;
and operating devices designed to define, at at least one of said ends of said metal insert, at least one modified area without plastic material.

10. Mould as claimed in claim 9, in which said operating devices comprise at least one punch that can be positioned in said moulding cavity and removed from the same in order to define at least one cavity in said shaped body.

11. Mould as claimed in claim 10, in which at least one actuator mechanism is provided designed to control the movements of said at least one punch.

12. Mould as claimed in claim 10, in which said ends define a main direction of development of said metal insert and in which said at least one punch moves crosswise to said main direction of development.

13. Mould as claimed in claim 10, in which said ends define a main direction of development of said metal insert and in which said at least one punch is substantially aligned with said main direction of development and moves parallel to the same.

14. Mould as claimed in claim 13, in which said at least one punch is provided for support of said metal insert.

15. Mould as claimed in claim 10, in which said punch has surfaces converging in the direction of said metal insert.

16. Mould as claimed in claim 9, in which said operating devices are produced by at least one spacer body embedded in said shaped body and deformable or shatterable by interference with said metal insert during shrinkage of the plastic material.

17. Mould as claimed in claim 16, in which said at least one spacer body is directly engaged in one said end of said metal insert.

18. Mould as claimed in claim 16, in which said spacer body is a block of elastically deformable material.

19. Mould as claimed in claim 16, in which said spacer body is a hollow collapsible shell.

20. Longitudinal member combining plastic and metal, comprising a metal insert having ends spaced from each other, a plastic shaped body at least partially incorporating said metal insert, and at least one -modified -area without plastic material corresponding to at least one of said ends, said modified area being at least one cavity in said plastic material open and running into at least one side of said shaped body.

21. Longitudinal member as claimed in claim 20, in which said at least one modified area includes at least one spacer body embedded in said plastic material at at least one of said ends.
